(19) United States
(12) Patent Application Publication
(10) Pub. No.: US 2006/0001259 A1
(43) Pub. Date: Jan. 5, 2006

(54) Mechanical and coil fusion combination seal

(76) Inventors: Robert V. Carter JR., Erie, PA (US); Carl R. Nicolia, Erie, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/128,426

(22) Filed: May 12, 2005

Related U.S. Application Data
(60) Provisional application No. 60/571,826, filed on May 17, 2004.

(51) Int. Cl. F16L 13/02

(52) U.S. Cl. 285/21.2

(57) ABSTRACT

A combination mechanical and fusion seal for use with a pipe includes a thermoplastic sleeve, wherein the thermoplastic sleeve includes a first portion constructed of a first material and a second portion constructed of a second material, wherein the first material has a lesser density and/or durometer than the density and/or durometer of the second material; an electrical resistive wire embedded within the second material; and at least one exposed lead attached to the resistive wire. A piping system utilizing the combination mechanical and fusion seal is disclosed. The present invention is also drawn to a method of joining the seal of the pipe to another pipe is also described.

### CROSS REFERENCE TO RELATED APPLICATIONS

This application claims the benefit of U.S. Provisional Patent Application No. 60/571,826, filed May 17, 2004, entitled “Mechanical and Coil Fusion Combination Seal”, the disclosure of which is hereby incorporated by reference.

### BACKGROUND OF THE INVENTION

1. Field of the Invention

This invention relates to coupling of plastic pipes and, more particularly, to coupling of plastic pipes by a fusion seal and/or a mechanical seal.

2. Description of Related Art

Prior to the advent of plastic pipe, most piping was made out of metal, such as copper, stainless steel, or iron. The particular metal used for the piping was dependent upon the application. For example, water could be transported through copper and/or cast-iron pipes. However, acids had to be transported in stainless steel pipe. Some of the metal pipe, such as copper and stainless steel, was expensive to manufacture and install. Typically, the pipe was either brazed or welded together. In some instances, mechanical type joints were provided for pipe connections. In today's market, all of these arrangements are expensive to manufacture and install.

Plastic pipe overcomes many of the expenses associated with metal pipe. Plastic pipe is inexpensive to manufacture and relatively easy and inexpensive to connect together. In the case of thermoplastic materials, such as polypropylene, the pipe can be welded together by providing a polypropylene sleeve with electrical heating elements embedded therein. This process is known as fusion welding. Fusion welded pipe is particularly applicable in situations where acid passes through the plastic pipe. Polypropylene pipes can be secured to each other through mechanical seals. In some applications, mechanical seals are preferable to the fusion welding.

In the past, different pipes and/or pipe couplings were provided for fusion sealing and mechanical sealing, such as those disclosed in U.S. Pat. Nos. 6,250,686 and 6,450,544, both to Becker et al., which are hereby incorporated by reference. This resulted in an increase in inventory required by the installer, such as the mechanical contractor or plumber, since different pipes were required to be used in different applications.

Accordingly, a need exists for a seal incorporating both a mechanical seal and a fusion seal that is able to provide a permanent fusion seal as well as provide an initial mechanical seal before the fusion process has been completed.

### SUMMARY OF THE INVENTION

The present invention is drawn to a combination mechanical and fusion seal for use with a pipe. The combination mechanical and fusion seal includes a thermoplastic sleeve, wherein the thermoplastic sleeve includes a first portion constructed of a first material and a second portion constructed of a second material, wherein the first material has a lesser density and/or durometer than the density and/or durometer of the second material. The seal also includes an electrical resistive wire embedded within the second material and at least one exposed lead attached to the resistive wire. Desirably, the first material is polyethylene and the second material is polypropylene and the electrical resistive wire is constructed of one of a nickel-chrome wire and a normal heating wire with nickel plate.

The first portion of the thermoplastic sleeve can include a first outer surface portion tapering outwardly with a frustum conical shape and a second outer surface portion that is cylindrically shaped and flat. The second portion of the thermoplastic sleeve can include a smooth and cylindrically shaped outer portion. Furthermore, the first portion of the thermoplastic sleeve also has an inner and outer diameter that is greater than the inner and outer diameter of the second portion of the thermoplastic sleeve.

Additionally, the present invention is drawn to piping system utilizing the aforementioned combination mechanical and fusion seal. The piping system includes a first pipe having a first end, a second end, an outer surface, and an inner surface, wherein the inner surface defines a passageway and a receiving profile at the first end, and further wherein a combination mechanical and fusion seal is secured within the receiving profile; and a second pipe having a first end and a second end, wherein the first end of the second pipe is received by the seal of the first pipe. Desirably, the first and second pipes are constructed of a thermoplastic material, such as polypropylene.

The outer surface of the first end of the first pipe can include a threaded portion defined thereon. The piping system can also include a nut threaded upon the threaded portion of the first pipe for securing the first end of the second pipe within the receiving profile of the first pipe. The second end of the first pipe can also be adapted to receive a third pipe and the second end of the second pipe can be adapted to receive a fourth pipe.

Finally, a method of joining two thermoplastic pieces of pipe is also disclosed. The method includes the steps of: providing a first pipe having a first end, a second end, an outer surface, and an inner surface, wherein the inner surface defines a passageway and a receiving profile at the first end, and further wherein a combination mechanical and fusion seal is secured within the receiving profile; providing a second pipe having a first end and a second end; and inserting the first end of the second pipe into the sleeve of the first pipe. The outer surface of the first end of the first pipe can include a threaded portion defined thereon and the method can further include the step of threading a nut upon the threaded portion of the first pipe. The nut provides a compressive force on the first end of the first pipe to secure the first end of the second pipe within the receiving profile of the first pipe. The method can further include the step of transmitting an electrical charge to the seal through the at least one exposed lead. The electrical charge melts the seal, melts a portion of the first end of the first pipe, and melts a portion of the first end of the second pipe to form a fluid-tight seal therebetween.

By providing a seal incorporating both a mechanical seal and a fusion seal, pipes within the piping system may be temporarily or permanently connected efficiently, without requiring application specific inventory or hardware.

Further details and advantages of the present invention will become apparent upon reading the following detailed description in conjunction with the accompanying drawings.

### BRIEF DESCRIPTION OF THE DRAWINGS

FIG. 1 is an elevational view of a combination mechanical and fusion seal, partially in section, with a partial exploded view thereof, in accordance with the present invention;

FIG. 2 is an elevational view, partially in section, of a first pipe incorporating the combination mechanical and fusion seal of FIG. 1, in accordance with the present invention;

FIG. 3 is an elevational view, partially in section, of a second pipe used in conjunction with the first pipe of FIG. 2;

FIG. 4 is an elevational view of a nut for threading onto the first pipe of FIG. 2;

FIG. 5 is an elevational view, partially in section, of the first pipe securing the second pipe therein by utilizing the mechanical seal of the combination mechanical and fusion seal with the nut;

FIG. 6 is an elevational view, partially in section, of two combination mechanical and fusion seals configured to serve as a coupling; and

FIG. 7 is an elevational view, partially in section, of the first pipe securing the second pipe therein by utilizing the fusion seal of the combination mechanical and fusion seal.

### DESCRIPTION OF THE PREFERRED EMBODIMENTS

The present invention will be described with reference to the accompanying figures, wherein like reference numbers correspond to like elements throughout.

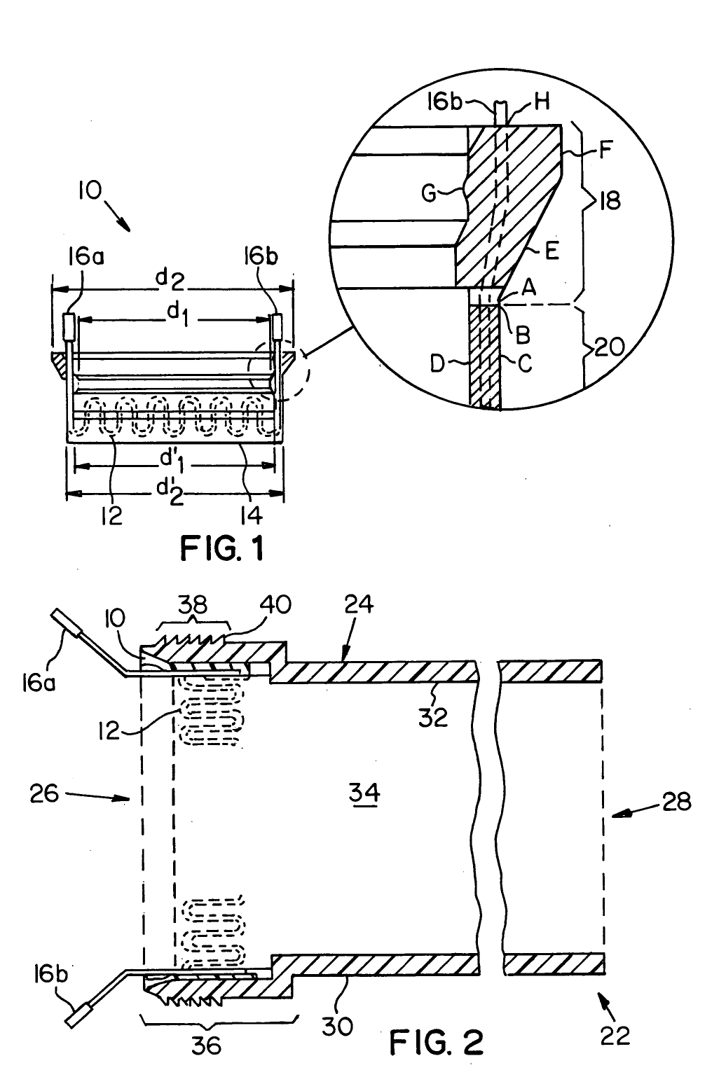

With reference to FIG. 1, a combination mechanical and fusion seal 10 is a unitary seal that includes a circumferential-looped electrical resistive wire 12 embedded within a cylindrical thermoplastic sleeve 14. Desirably, the electrical resistive wire 12 or heating element is constructed of nickel-chrome or a normal heating wire with nickel plate. Desirably, the electrical resistive wire 12 is made of eighteen (18) gauge wire and has a resistance measured in ohms per inch. The resistance of the electrical resistive wire 12 varies depending on the application. Optionally, exposed electrical resistive wire leads 16a and 16b may be attached to respective exposed portions of the electrical resistive wire 12. The thermoplastic sleeve 14 includes a uniform body that is constructed of at least two materials.

Specifically, the two materials form a first portion 18 attached to a second portion 20 of the thermoplastic sleeve 14 at respective ends A and B, as shown in the exploded view of FIG. 1. Desirably, ends A and B are fused to each other. Generally, the first thermoplastic material has a lesser density and/or durometer than the density and/or durometer of the second material. The first thermoplastic material may have a durometer range of 50 to 89 A ASTM-D2240 and a density range of 0.919 g/cc (±15%), whereas the second thermoplastic material may have a durometer range of 70-80 R Rockwell Hardness ASTM-D785 and a density range of 0.902 g/cc (±15%). For example, although both the first material and the second material are thermoplastic materials, desirably, the first material is a soft flexible material similar to low-density polyethylene material such as Mobilbrand LQA-006 low-density polyethylene manufactured by Mobil Polymers, 2195 Lincoln Highway, Edison, N.J. 08818 or the like, whereas the second material is ProFax 8723 polypropylene manufactured by Basell North America Inc., 912 Appleton Road, Elkton, Md. 21921.

In addition to being constructed of a flexible material, the inside of the first portion 18 of the thermoplastic sleeve 14, as shown in greater detail in the exploded view of FIG. 1, is shaped so as to provide a compression fit for any pipe that may be inserted therein. Hence, the first portion 18 of the thermoplastic sleeve 14 may be considered the mechanical seal portion of the combination mechanical and fusion seal 10. The second portion 20 of the thermoplastic sleeve 14 includes the electrical resistive wire 12 embedded in the first portion 18 and the second portion 20 and may therefore be considered the fusion seal portion of the combination mechanical and fusion seal 10. As can be seen in FIG. 1, an outer surface C and inner surface D of second portion 20 are smooth and cylindrically shaped. An outer surface portion E of the first portion 18 tapers outwardly and is frustum conical shaped, and an outer surface portion F of the first portion 18 is cylindrically shaped and flat, an inner surface G of the first surface includes a plurality of sections and varies in diameter. A diameter d₁ of the first portion 18 is greater than an inner diameter d₁′ of the second portion 20 and an outer diameter d₂ of the first portion 18 is greater than a second diameter d₂′ of the second portion 20.

With reference to FIG. 2, and with continuing reference to FIG. 1, a first pipe 22 incorporating the combination mechanical and fusion seal 10 includes a body 24 that is desirably constructed of a thermoplastic material, such as polypropylene. Body 24 includes a first end 26, a second end 28, an outer surface 30, and an inner surface 32. A passageway 34 is defined by inner surface 32 of body 24. Generally speaking, body 24 is substantially cylindrical in shape, although body 24 may assume other shapes that may be conducive to either flow of material within body 24 or other application specific purposes. Therefore, passageway 34 may also be substantially cylindrical in shape. However, it is to be understood that passageway 34 defined within body 24 may assume other forms including, but not limited to, square, rectangular, or triangular, even if the external shape of body 24 is different. Passageway 34 extends from the first end 26 to the second end 28 of body 24. The inner surface 32 of body 24 defines a receiving profile 36 at the first end 26 of body 24. The receiving profile 36 is sized to accommodate an end of another pipe or some other connection end, such as an inlet/outlet. Desirably, the receiving profile 36 is of unitary construction with body 24, although, as shown in FIG. 1, the first end 26 may have a greater circumference than any other circumferential portion of body 24 due to the location of the receiving profile 36. It is to be understood that the outer surface 30 and the inner surface 32 of body 24 may encompass the respective outer and inner surfaces of the receiving profile 36. A threaded portion 38 may be defined on the outer surface 30 around the first end 26 of the body 24. Desirably, threaded portion 38 is situated along the outer surface 30 of the receiving profile 36. Threaded portion 38 includes one or more molded threads 40 that are preferably unitary with body 24. Alternatively, threaded portion 38 may be a separate threaded piece (not shown) that is affixed around the first end 26. Although it is preferred that the threads 40 are situated around the entire circumference of the first end 26, it is to be understood that the threads 40 may be situated only partially around the circumference. Furthermore, threaded portion 38 and/or the threads 40 may be substituted with a clamping or tension locking mechanism that performs a function equivalent to that of the threads 40.

As shown in FIG. 2, the combination mechanical and fusion seal 10 is seated within first pipe 22 and, more specifically, within the interior of the receiving profile 36 of first pipe 22. Desirably, the inner diameter of thermoplastic sleeve 14 is slightly larger than the inner diameter of the receiving profile 36 so that a friction and pressed fit is formed when the combination mechanical and fusion seal 10 is secured within the receiving profile 36.

It is to be understood that the second end 28 of body 24 of the combination mechanical and fusion seal 10 may be of the same diameter as body 24, excluding the increase of the diameter due to the receiving profile 36. This allows the second end 28 to be inserted into another receiving profile of another pipe, similar in construction to the receiving profile 36 of the first end 26.

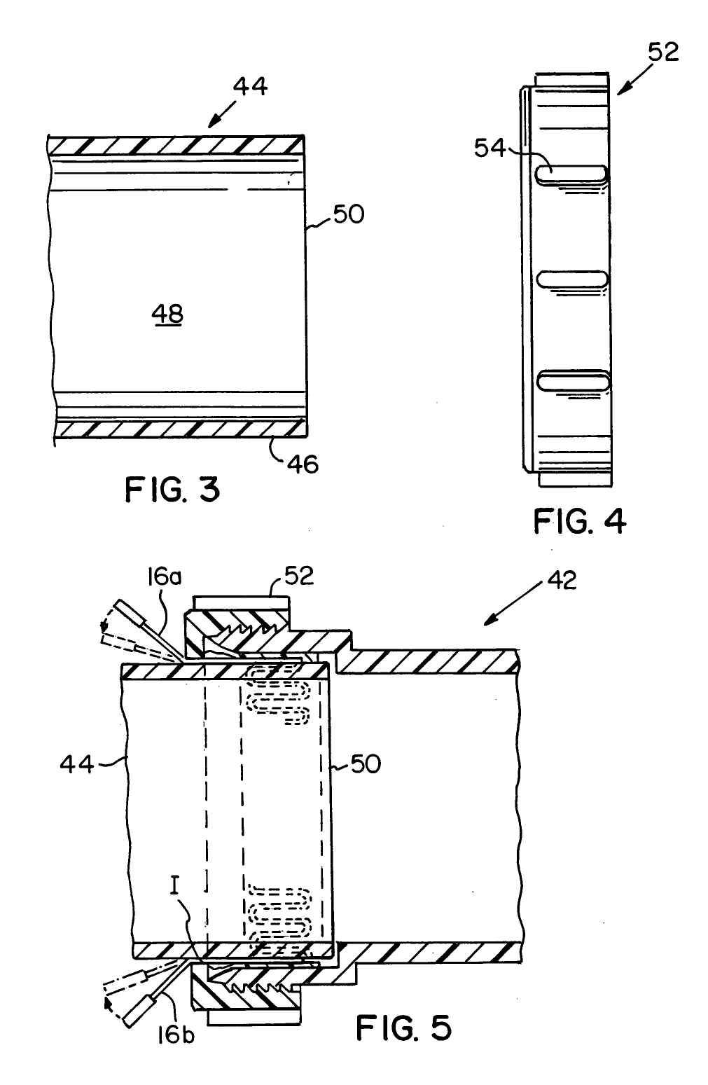

With reference to FIGS. 3-5, and with continuing reference to FIGS. 1 and 2, a piping system 42 may be formed by using the combination mechanical and fusion seal 10 in the first pipe 22 in conjunction with at least one other pipe, such as a connecting pipe 44. Specifically, as depicted in FIG. 3, the connecting pipe 44 includes an outer surface 46, a passageway 48, and an end 50 for insertion into the first pipe 22. The connecting pipe 44 may be of any dimension as long as the end 50 is adapted to be received by the combination mechanical and fusion seal 10 of the receiving profile 36 of the first pipe 22. Desirably, the outside diameter of the end 50 is sized so as to create a friction fit between connecting pipe 44 and the combination mechanical and fusion seal 10. Thus, the first portion 18 of the combination mechanical and fusion seal 10 is utilized to create a mechanical seal between the first pipe 22 and the connecting pipe 44. The mechanical seal provides leak resistance and the ability to quickly and easily loosen a connection between pipes 22 and 44. Thus, the piping system 42 may then be utilized in any application where a mechanical seal is sufficient, such as a test run of water or flow of a non-hazardous substance. The mechanical seal may be undone by simply moving the connecting pipe 44 away from the first pipe 22. The mechanical seal may be strengthened by utilizing a nut 52, as shown in FIG. 5. The nut 52 is threaded so that the nut 52 may threadably engage the threaded portion 38 of the body 24 of the first pipe 22. The nut 52 may be constructed of the same material as the body 24. Axially extending ribs 54 are positioned about an outer surface of the nut 52. It is to be understood that if the resistive wire leads 16a and 16b are bent in an outward-angled position, they may be easily bent toward each other (as shown in phantom) to create sufficient clearance for the nut 52 to pass over the resistive wire leads 16a and 16b in order to threadingly engage the body 24. Typically, as the nut 52 is tighter, it contracts end H of the first portion 18 of the combination mechanical and fusion seal 10 forcing the surface G against the outer surface of pipe 44, and forcing at least portions of surfaces E and F against the inner surface of pipe 22, thereby forcing a liquid tight seal. Thereafter, the resistive wire leads 16a and 16b may be bent back to their original outward-angled position.

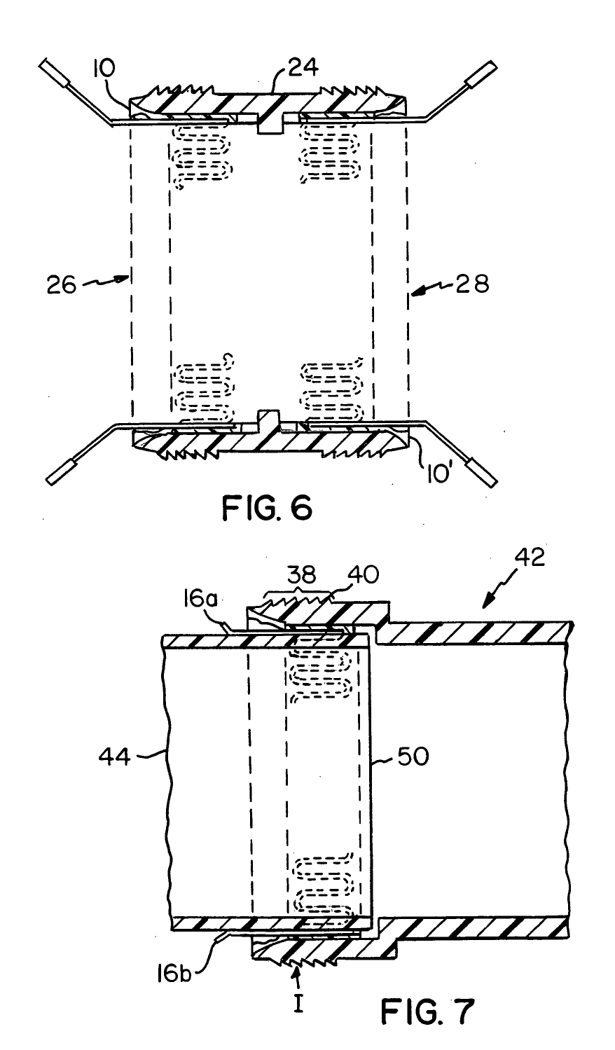

With reference to FIG. 6, and with continuing reference to FIGS. 1-5, the combination mechanical and fusion seal may be used as part of a pipe coupling system. When used in a coupling system, the second end 28 of body 24 is of similar construction to the first end 26 of body 24. Specifically, the second end 28 may also include none, one, or all of the following: another receiving profile, another threaded portion, and another combination mechanical and fusion seal 10′. By utilizing all three of these elements, a coupling is formed that is adapted to join two pipes having a congruous diameter. U.S. Pat. No. 6,450,544 to Becker et al., which is hereby incorporated herein by reference, discloses the use of a coupling to couple a thermoplastic pipe having a fusion seal on its outer surface to another pipe. Thus, the present invention may also be utilized to perform such a coupling function.

With reference to FIG. 7 and with continuing references to FIGS. 1-5, the method of fusion sealing the connecting pipe 44 to the first pipe 22 will now be described. Initially, the end 50 of connecting pipe 44 is inserted into the receiving profile 36 of the first pipe 22. Thus, the passageway 48 of the connecting pipe 44 is in fluid communication with the passageway 34 of the first pipe 22. Forming the fusion seal, as shown in FIG. 6, involves passing an electric current having a voltage of typically 120 volt AC, through the electrical resistive wire 12 via the resistive wire leads 16a and 16b. The electric current causes the electrical resistive wire 12 to heat, thereby causing the thermoplastic sleeve 14 and adjacent portions of the outer surface 46 of the connecting pipe 44 and the inner surface 32 of the receiving profile 36 to melt. A clamp, such as a hose clamp (not shown), may be used to squeeze the pipes 22 and 44 adjacent the second portion 20, as indicated at arrow I. Alternatively, the nut 52 may be used for this purpose. After a period of time, the electric current is stopped from passing through the electrical resistive wire 12. The first pipe 22 and the connecting pipe 44 are permitted to cool and harden, thereby forming a fluid-tight seal therebetween. The exposed resistive wire leads 16a and 16b and the respective exposed portions of the electrical resistive wire 12 may then be cut and removed from the thermoplastic sleeve 14. Alternatively, the exposed resistive wire leads 16a and 16b may be left alone for future heating and melting of the thermoplastic sleeve 14, should a leak develop or any of the pipes 22 and 44 have a need to be replaced. Once a fusion connection is established, additional leak resistance is introduced to the piping system 42 as well as a more permanent bond between pipes 22 and 44. Thus, an exemplary use of the piping system 42 when using the fusion seal may be in a polypropylene chemical drainage system.

It is to be understood that the pipes 22 and 44 may be both mechanically sealed and fusion sealed. For example, during the initial installation of the piping system 42, the pipes 22 and 44 may be mechanically sealed to secure the pipes while laying out or arranging the piping system 42. Thereafter, when the arrangement of pipes 22 and 44 has been finalized, the pipes 22 and 44 may be fusion sealed. The nut 52 may remain on the first pipe 22 even after the first pipe 22 and the connecting pipe 44 have been fusion sealed. It is also to be understood that, although thermoplastic is the preferable material for the components making up the invention, it is contemplated that other plastic materials or copolymers can be used.

The present invention has been described with reference to the preferred embodiments. Obvious modifications, combinations, and alterations will occur to others upon reading the preceding detailed description. It is intended that the invention be construed as including all such modifications, combinations, and alterations insofar as they come within the scope of the appended claims or the equivalents thereof.

The invention claimed is:

1. A combination mechanical and fusion seal for use with a pipe, wherein the seal is comprised of:
a thermoplastic sleeve, wherein the thermoplastic sleeve includes a first portion constructed of a first material and a second portion constructed of a second material;
an electrical resistive wire embedded within the second material; and
at least one exposed lead attached to the resistive wire.

2. The combination and fusion seal as claimed in claim 1, wherein the first material has a at least one of a lesser density and durometer than the at least one of density and durometer of the second material;

3. The combination mechanical and fusion seal of claim 1, wherein the first material is polyethylene and the second material is polypropylene.

4. The combination mechanical and fusion seal of claim 1, wherein the electrical resistive wire is constructed of one of a nickel-chrome wire and a normal heating wire with nickel plate. 1

5. The combination mechanical and fusion seal of claim 1, wherein the first portion has a first outer surface portion tapering outwardly with a frustum conical shape and a second outer surface portion is cylindrically shaped and flat.

6. The combination mechanical and fusion seal of claim 1, wherein the second portion includes a smooth and cylindrically shaped outer portion.

7. The combination mechanical and fusion seal of claim 1, wherein an inner diameter of the first portion is greater than an inner diameter of the second portion.

8. The combination mechanical and fusion seal of claim 1, wherein an outer diameter of the first portion is greater than an outer diameter of the second portion.

9. A piping system comprising:
a first pipe having a first end, a second end, an outer surface, and an inner surface, wherein the inner surface defines a passageway and a receiving profile at the first end, and further wherein a seal is secured within the receiving profile, wherein the seal is comprised of:
a thermoplastic sleeve, wherein the thermoplastic sleeve includes a first portion constructed of a first material and a second portion constructed of a second material;
an electrical resistive wire embedded within the second material; and
at least one exposed lead attached to the resistive wire; and
a second pipe having a first end and a second end, wherein the first end of the second pipe is received by the seal of the first pipe.

10. The piping system of claim 9, wherein the first material has at least one of a lesser density and durometer than the at least one of density and durometer of the second material;

11. The piping system of claim 9, wherein the outer surface of the first end includes a threaded portion defined thereon.

12. The piping system of claim 11, further comprising a nut threaded upon the threaded portion of the first pipe, the nut securing the first end of the second pipe within the receiving profile of the first pipe.

13. The piping system of claim 8, wherein the first pipe and the second pipe are constructed of a thermoplastic material.

14. A method of joining two plastic pieces of pipe, the method comprising the steps of:
providing a first pipe having a first end, a second end, an outer surface, and an inner surface, wherein the inner surface defines a passageway and a receiving profile at the first end, and further wherein a seal is secured within the receiving profile, wherein the seal is comprised of:
a thermoplastic sleeve, wherein the thermoplastic sleeve includes a first portion constructed of a first material and a second portion constructed of a second material,
an electrical resistive wire embedded within the second material; and
at least one exposed lead attached to the resistive wire;
providing a second pipe having a first end and a second end; and
inserting the first end of the second pipe into the sleeve of the first pipe.

15. The method of claim 14, wherein wherein the first material has at least one of a lesser density and durometer than the at least one of density and durometer of the second material.

16. The method of claim 14, wherein the outer surface of the first end includes a threaded portion defined thereon.

17. The method of claim 16, further comprising the step of threading a nut upon the threaded portion of the first pipe.

18. The method of claim 17, wherein the nut provides a compressive force on the first end of the first pipe to secure the first end of the second pipe within the receiving profile of the first pipe.

19. The method of claim 14, further comprising the step of transmitting an electrical charge to the seal through the at least one exposed lead.

20. The method of claim 19, wherein the electrical charge melts the seal, melts a portion of the first end of the first pipe, and melts a portion of the first end of the second pipe to form a fluid-tight seal therebetween.
